(19) United States
(12) Patent Application Publication
(10) Pub. No.: US 2015/0081356 A1
(43) Pub. Date: Mar. 19, 2015

(54) DYNAMIC MULTI-DIMENSIONAL BUSINESS REPORTS

(71) Applicant: Microsoft Corporation, Redmond, WA (US)

(72) Inventors: April Olson, West Fargo, ND (US); Christopher Ahlers, Fargo, ND (US); Jill Carter, Riles Acres, ND (US); Andreas Arff, Fargo, ND (US); Tristan Cartony, West Fargo, ND (US)

(73) Assignee: Microsoft Corporation, Redmond, WA (US)

(21) Appl. No.: 14/029,420

(22) Filed: Sep. 17, 2013

(51) Int. Cl. G06Q 10/06

(52) U.S. Cl. CPC G06Q 10/0631
USPC 705/7.12

(57) ABSTRACT

Technologies are generally described for providing dynamic report views of multi-dimensional business data. An enterprise resource planning (ERP) system may facilitate data collection of user requested data for a dimension, such as a time interval, and presentation of the data in a data report. The data report may initially display an initial granularity of the data displaying the requested dimension. During data collection for the requested data, multiple dimensions of data related to the requested data may also be collected, and the data for the additional dimensions may be rendered in the background to enable the data to be dynamically presented in the report upon request by a user without having to retrieve new data. The user may select to view one or more additional intervals of data on the initial data report, and the data report may automatically refresh to display the selected data intervals.

### BACKGROUND

Enterprise resource planning (ERP) applications may enable users to generate a variety of reports related to business processes such as financial reports, including accounting, profits and revenue data, inventory reports, and other business process reports. Users may request an initial report from the ERP, and the ERP may generate a data query to collect the data for the requested report from an external database and generate the report. After receiving the generated report from the ERP at a local device associated with the user, the user may desire to view more detailed data related to the report. When the user selects to view more detailed data, the ERP may receive the request and generate a new data query to retrieve the more detailed data from the database. Enterprise data may be complex, and there may be large amounts of enterprise data stored in the external database. Generating a new data query each time a user requests to view more data may be inefficient and time consuming as the request may be received over a network, and the large amounts of data stored in the database may take time to process and parse. Additionally, it may take even more time to retrieve the requested data, generate a report from the data and provide the report to the user from the external database to the user's local device over the network.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing dynamic report views of multi-dimensional business data. An enterprise resource planning (ERP) or similar platform may facilitate data collection of requested business data and present the requested data in a multi-dimensional data report. The multi-dimensional data report may initially display year-to-date data for the requested data. During the data collection for the requested data, additional intervals of data may also be collected such as monthly and quarterly, and the data may be rendered in the background to enable the data to be dynamically presented upon user request. A user may select to view one or more additional intervals of data on the initial data report, and the data report may automatically refresh to display the selected data intervals. The ERP platform may perform a defined set of calculations to determine the data to be included in each data interval, and may enable a user to customize the data interval presentation according to user preferences.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example networked environment where an enterprise resource planning platform may provide multi-dimensional business reports;

FIG. 2 illustrates an example year to date multi-dimensional business report;

FIG. 3 illustrates an example multi-dimensional business report including quarterly data;

FIGS. 4A and 4B illustrate an example multi-dimensional business report including monthly and quarterly data and example graphical visualizations of the multi-dimensional business report;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of providing dynamic report views of multi-dimensional business data, according to embodiments.

### DETAILED DESCRIPTION

As briefly described above, a system is described for providing dynamic report views of business data. An enterprise resource planning (ERP) or similar platform may collect requested enterprise data and present the requested data in a data report. The data report may initially display year-to-date data for the requested data, and during the data collection for the requested data, additional intervals of data may also be collected. The additional data intervals may be generated in the background to enable the data to be dynamically presented upon user request. A user may select to view one or more additional intervals of data on the initial data report, and the data report may automatically refresh to display the selected data intervals.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

Throughout this specification, the term “platform” may be a combination of software and hardware components for providing dynamic report views of multi-dimensional business data. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

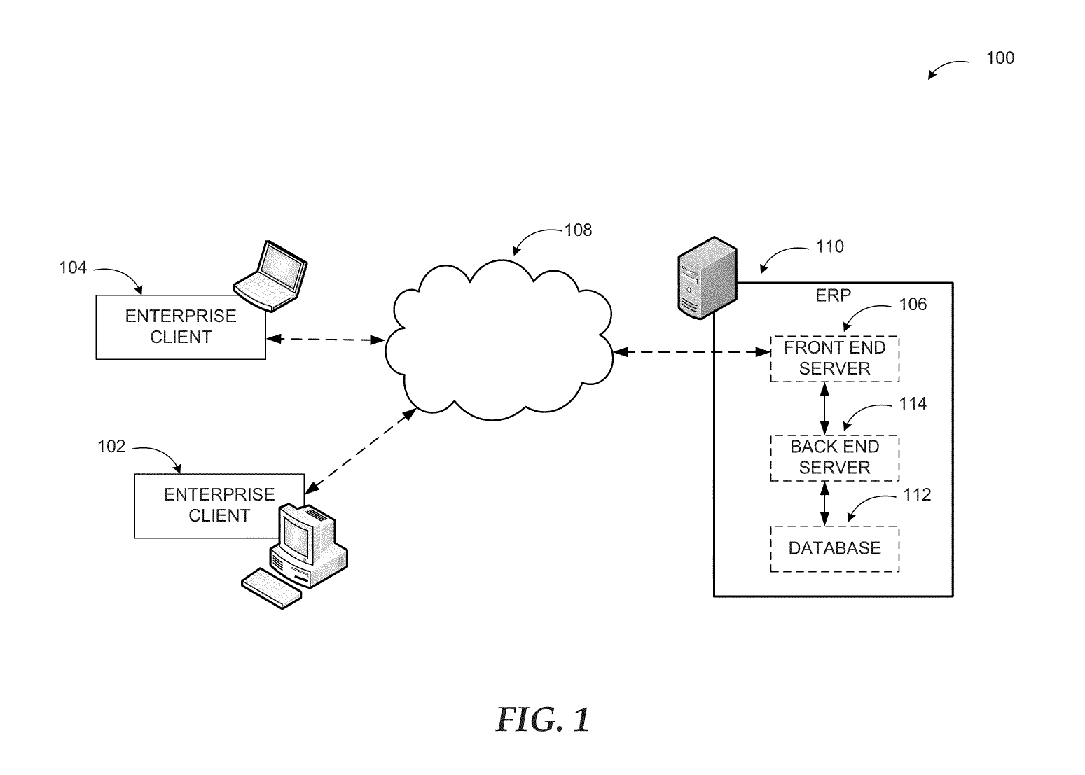

FIG. 1 illustrates an example networked environment where an enterprise resource planning platform may provide multi-dimensional business reports, according to some embodiments, herein.

As illustrated in diagram 100, an enterprise resource planning (ERP) system 110 may provide support for internal business processes of an enterprise or company. For example, the ERP systems 110 may provide a real time integrated view of business processes such as production, order processing, and inventory management tied together by an enterprise management system and a central database storing enterprise data. Some example ERP system 110 may track resources such as cash, raw materials, and production capacity, customer orders, purchase orders, inventory management, and payroll in departments such as manufacturing, accounting, purchasing and sales. The ERP system 110 may provide various reports to users associated with the enterprise over a network 108 such as a cloud based network. Users (102, 104) associated with the ERP system 110 may access the enterprise data over the network 108, and may request a report of the enterprise data over the network 108. The users (102, 104) may access and interact with the report on the user's own client device such as a personal computer, laptop, tablet, or smartphone. The enterprise data and associated reports may be accessed over a web browser executed on the user's client device, and may also be accessed and stored locally on the user's client device.

In an example embodiment, a front end server 106 of the ERP system 110 may receive a request to collect data from an enterprise database 112 and may generate a multi-dimensional business report for the requested data. Example multi-dimensional business reports may include financial reports such as ledgers, trail balance data, overall balance sheets and quarterly financial statements, and may include reports related to other aspects of the business such as purchase orders and inventory. The front end server 106 may receive the data request query and may route the data request query to a back end server 114 configured to retrieve the requested data. The back end server 114 may generate a data query to retrieve the requested data from the database 112.

In an example embodiment, when the initial data request is received for a portion of multi-dimensional business data, the back end server 114 may generate the data query to retrieve the requested portion of multi-dimensional business data, and to retrieve dimensions of data related to the initial requested portion. For example, if the request is to retrieve the year-to-date financial data, the back end server 114 may generate the query to retrieve each segmented dimension of data making up the year-to-date financial data, such as the weekly, monthly, and quarterly data dimensions. After the back end server 114 retrieves the data from the database 112, the back end server 114 may provide the data to the front end server for rendering of the data. The front end server 106 may create a single report for the requested portion of data and may render the additional dimensions of related data in background. Additionally, the front end server 106 may create multiple reports for each dimension of collected data, and each of the generated reports may be stored on a user's local device for instant retrieval without having to retrieve data over the network 108 each time a user requests new data.

In a system according to embodiments, an example multi-dimensional business report may provide multi-dimensional business data over a period of time. The multi-dimensional business data may be presented in a year-to-date column in the multi-dimensional business report, where the year-to-date column may include one or more additional data columns defined by the user. The user requesting the year-to-date multi-dimensional business report may define the information, or columns and rows, the user desires to view in the report. For example, the user may desire to see a budget column, an actual amount spent column, and a marginal column. The user requesting the year-to-date multi-dimensional business report may desire to view more detailed views, or other dimensions, of the multi-dimensional business data in the year-to-date multi-dimensional business report. For example, the user may desire to view smaller time periods of multi-dimensional business data, such as quarterly, monthly, biweekly, weekly, daily, or other defined time period. A system according to embodiments may enable a multi-dimensional business report to dynamically display smaller time periods of data based on gathered year-to-date data initially provided in the multi-dimensional business report.

The computing device and user interface environment shown in diagram 100 are for illustration purposes. Embodiments may be implemented in various local, networked, and similar computing environments employing a variety of computing devices and systems. Data associated with an enterprise may be hosted at the ERP system, and in other embodiments the data may be hosted by a separate server accessible by the ERP system 110 for generating user requested enterprise reports. Furthermore, while multi-dimensional business data is described for generating a report and enabling display of smaller time periods of data for a year-to-date multi-dimensional business report, other multi-dimensional and hierarchical data may also be provided in a data report, and subsets of the hierarchical data may be displayed based on the initial set of data.

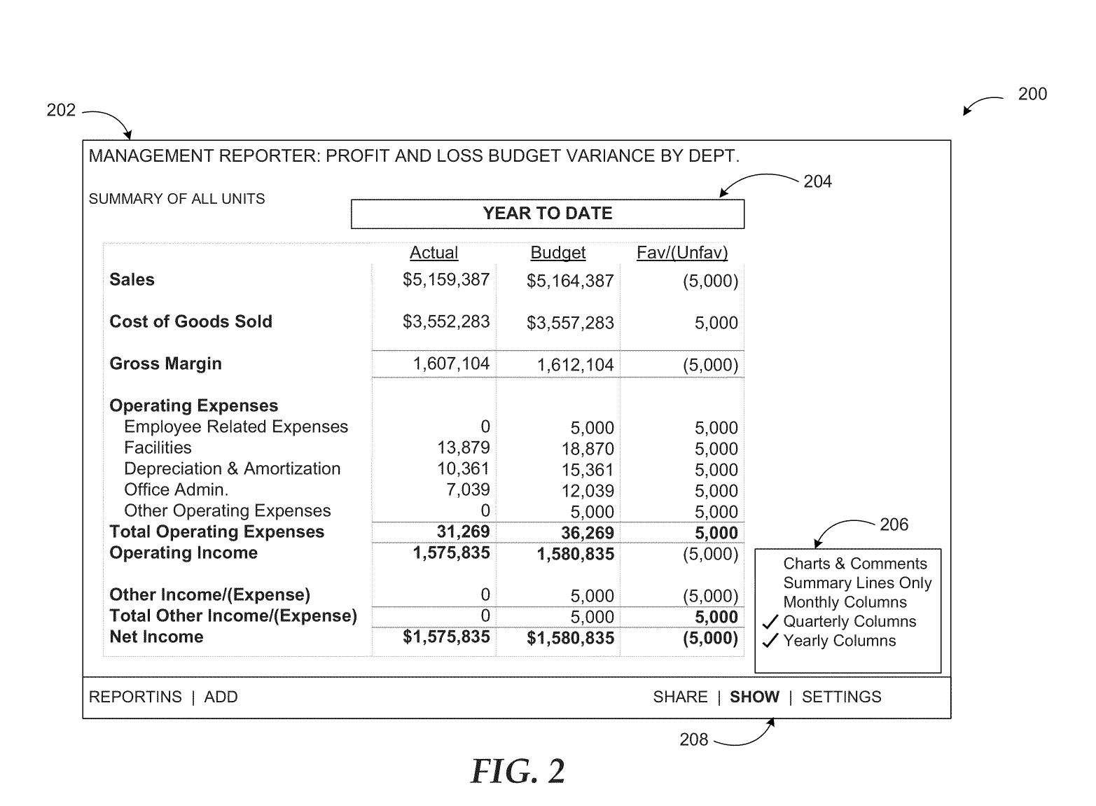

FIG. 2 illustrates an example year to date multi-dimensional business report, according to some embodiments, herein.

As illustrated in diagram 200, a multi-dimensional business report 202 may provide year-to-date data 204 related to a selected department or division of an entity. The data provided in the multi-dimensional business report 202 may be customized according to a user's report definition when the user requests the report. For example, the user may define rows and columns to be presented in the report during the initial data request. In the example multi-dimensional business report 202 shown in diagram 200, the user may define columns to be included in the multi-dimensional business report such as actual, budget, and variance columns which may provide data related to actual expenses, budgeted expenses and the favorable or unfavorable variance between actual and budgeted expenses. The rows may also be defined so that the user may select to view desired data for the selected columns.

In an example embodiment, when the user requests the multi-dimensional business report 202 from an ERP system, the ERP system may gather the requested data for the report from an enterprise database, and may generate the multi-dimensional business report with data for the requested rows and columns of the data report. The multi-dimensional business report 202 may initially display the requested multi-dimensional business data. For example, if the user requests year-to-date financial data, then the year-to-date data may be displayed in the report. The user may desire to view more detailed data in the multi-dimensional business report 202, such as smaller time periods or intervals of multi-dimensional business data, such as quarterly and monthly data.

In a system according to embodiments, the multi-dimensional business report 202 may be configured to dynamically display additional time periods of data according to a user's preferences based on the initial year-to-date data included in the multi-dimensional business report 202. The user may be enabled to select an interval to view in the multi-dimensional business report, and the multi-dimensional business report may automatically refresh to display the selected intervals of data, without having to retrieve and process the selected intervals of data from the enterprise database.

In a system according to embodiments, in order to facilitate dynamically displaying additional dimensions of data upon user selection, when a user requests a financial report from the ERP system, the ERP system may collect the requested data to generate the financial report. When the requested data is collected from the enterprise database, additional dimensions of the data may be also collected and rendered in the background of the multi-dimensional business report 202 to enable dynamic viewing of the data. During the report generation, the additional dimensions of data, such as additional time intervals of data including monthly, quarterly, weekly, and bi-weekly data for the columns and rows defined by the user, may be rendered. The additional data may be rendered in a single report and may be provided in the background for dynamically displaying, or in other embodiments, the additional data may be rendered in separate reports and provided with the requested report to the user's client device. The generated report, including the additional rendered data, may be provided to the user, and in a default view, the multi-dimensional report may display the requested data, such as year-to-date data 204. The data for the additional time period intervals may rendered in the background, but may not be displayed in the multi-dimensional report until the user selects to view the data.

In an example embodiment, a show option 208 may be provided to enable the user to select data interval views of the multi-dimensional business report. Upon selection of the show option 208, a list 206 of data interval views available for the multi-dimensional business report. The user may select one or more additional intervals to be displayed, and the report view may automatically refresh to display the selected intervals of data. When the user selects to see monthly columns in the multi-dimensional report 202, the report view may dynamically update to display monthly columns. Similarly, when the user selects to see quarterly columns in the multi-dimensional report 202, the report view may dynamically update to display quarterly columns, and likewise, when the user selects to see a yearly column in the report, the report view may dynamically update to display yearly columns. If the user selects to view two or more intervals, the report view may update to display the two or more selected monthly, quarterly and yearly intervals. In an example embodiment, the additional intervals available for selection from the list 206 may be dependent on the initially displayed report, such that sub-dimensions of a displayed dimensions may be available options for display. For example, if the initial report is a year-to-date report including a year-to-date column of financial data, then monthly and quarterly intervals may be options for selection. If the initial multi-dimensional business report is a periodic report displaying various time intervals defined by a user, but not including a year-to-date column, then quarterly and monthly data intervals may not be displayed as available report view options in the list 206.

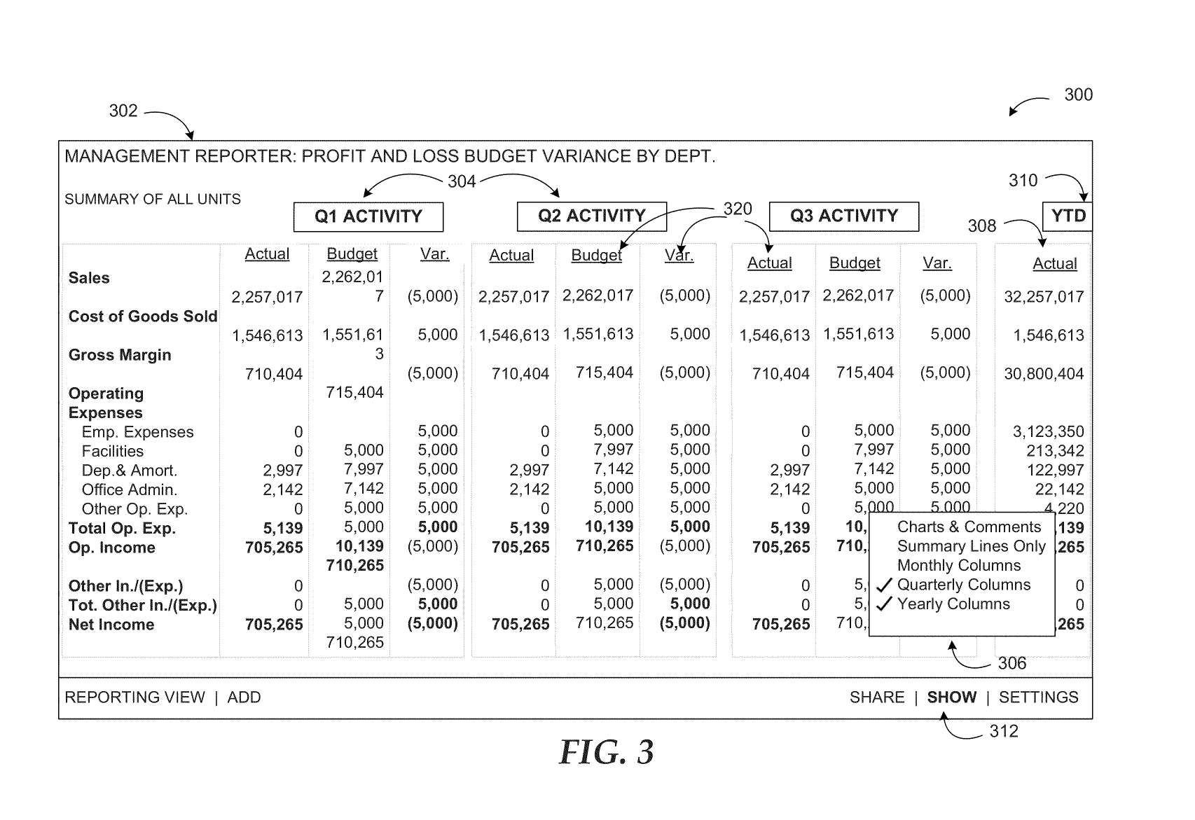

FIG. 3 illustrates an example multi-dimensional business report including quarterly data, according to some embodiments, herein.

In a system according to embodiments, a user may select to view quarterly data from an initial year-to-date multi-dimensional business report 302. The user may select to view the quarterly data by selecting a view option 312 presented on the multi-dimensional business report to present a list 306 of available data intervals and selecting one or more data intervals from the list 306. As illustrated in diagram 300, upon detection of a selection to view the quarterly data from the list 306, the multi-dimensional business report 302 may dynamically update to display one or more quarterly intervals 304 of data associated with the year-to-date data. The data columns 320 displayed in each quarterly interval 304 may coincide with the data columns 308 displayed in the year-to-date column 310 of the multi-dimensional business report 302. For example, if the year-to-date column 310 includes actual, budget, and variance columns, each quarterly interval 304 column may include the same actual budget, and variance columns with respective quarterly data values.

In a system according to embodiments, when an ERP system initially gathers the data from an enterprise database for the requested year-to-date report, the ERP system may also gather the data for quarterly and monthly intervals. Data to be included in each of the quarterly intervals 304 may be determined by calculating periods defined in the ERP system for year-to-date data. Example periods may be a number of months included in the year-to-date. A Periods-Per-Quarter (PPQ) value may be derived by dividing the number of periods defined in the year-to-date by 4. For example, if in a year-to-date report, there are 12 months, or periods, defined in the year-to-date, the PPQ value would be 3 (e.g. 12/4). If the total number of periods for the year-to-date defined by the ERP system is not a factor of 4, then the PPQ value may be rounded down to the nearest whole number. For example, if there are 14 periods defined in the year-to-date, the PPQ would be 3 e.g. 14/4=3.5. In another example, if there are 18 periods in the year-to-date, the PPQ would be 4 e.g. 14/4=4.5.

Furthermore, the number of periods in the year-to-date report may be divided by the PPQ value to determine the number of quarterly columns to display. Any remainder from this calculation may be added to the final column as a partial quarterly interval. For example, assuming a PPQ value of 3 and the year-to-date report generated for 6 periods, 2 quarterly columns may be added to the report view, and each quarterly column may include data for 3 periods, or 3 months of data. In another example, assuming a PPQ value of 3 and the year-to-date report generated for 7 periods, 3 quarterly columns may be added to the report. The first two quarterly columns may contain 3 periods of data and the third quarterly column may include only one period of data. In a further example, assuming a PPQ value of 3 and the year-to-date report generated for 14 periods, 4 quarterly columns may be added. The first two columns may contain 3 periods of data and the fourth quarterly column may include 2 periods.

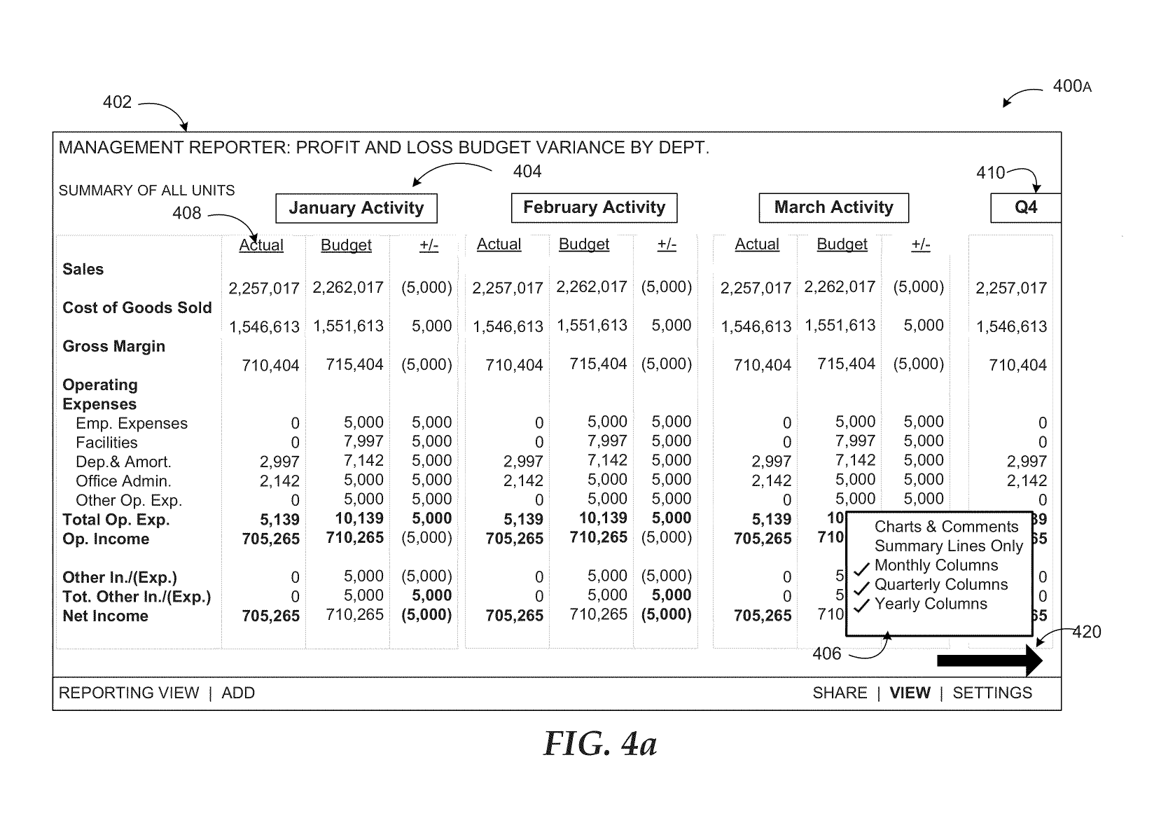

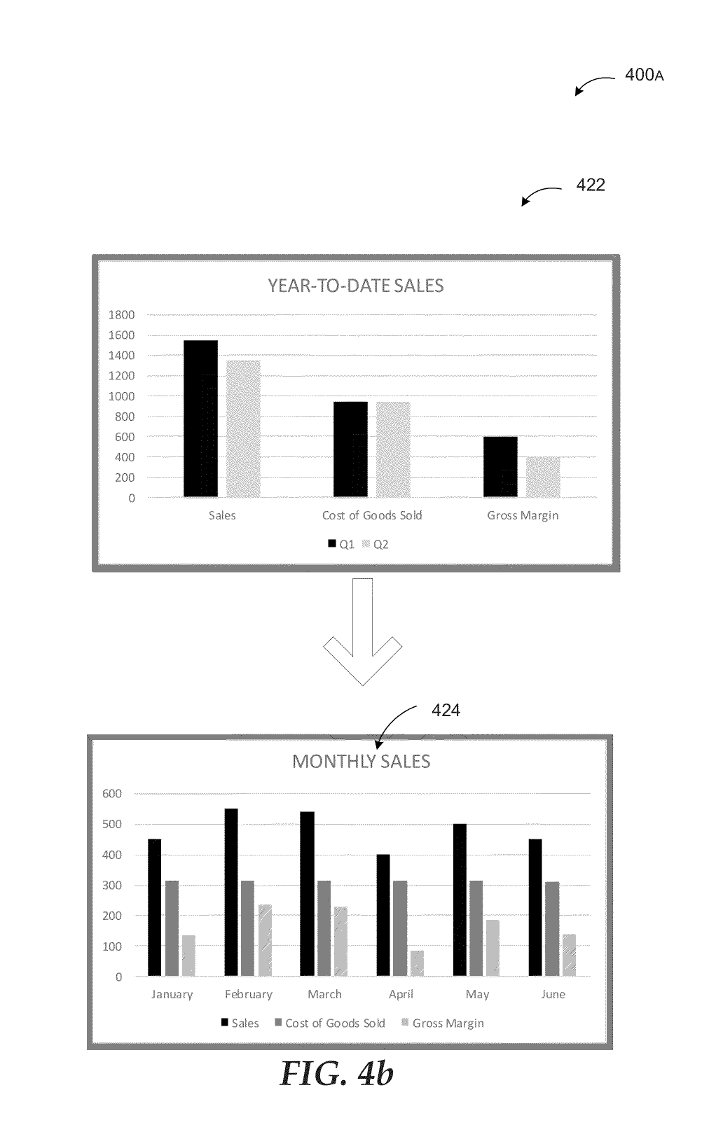

FIGS. 4A and 4B illustrate an example multi-dimensional business report including monthly and quarterly data and example graphical visualizations of the multi-dimensional business report, according to some embodiments, herein.

As illustrated in diagram 400A, a multi-dimensional business report 402 such as a financial report may also dynamically update to display data for monthly intervals 404 and quarterly intervals 410 concurrently. In an example embodiment, a user may select to view one or more of monthly intervals, quarterly intervals, and yearly intervals from an initial year-to-date financial report. The user may select the data intervals to view from a list 406 presented as part of the multi-dimensional business report. The user may select a show option presented on a menu bar of the multi-dimensional business report to display the list 406. Upon detection of a selection to view the data intervals from the list 406, the multi-dimensional business report 402 may automatically update to present the selected data intervals.

In an example embodiment, when monthly intervals 404 are selected, data to be displayed in the monthly interval 404 columns of the multi-dimensional business report may be determined based on periods defined for the year-to-date in an ERP system. The number of monthly interval 404 columns added to the multi-dimensional business report may be determined based on the period the multi-dimensional business report 402 is generated for. For example, if the multi-dimensional business report 402 is generated for period 5 (i.e. the year-to-date for five periods), then 5 monthly interval columns may be added to the multi-dimensional business report 402 view. The data columns 408 displayed in each monthly interval 404 may coincide with the data columns displayed in the quarterly and/or the year-to-date column of the multi-dimensional business report 402.

In another example embodiment, if the user selects to view monthly and quarterly data concurrently in the multi-dimensional business report, monthly intervals 404 and quarterly intervals 410 may be added to the report. The data to be included in each of the monthly intervals may be calculated as described above. Each quarterly interval 410 column may be displayed after the group of monthly intervals 404 that display the data included in the quarterly interval 410. For example, assuming a PPQ value of 3 and the year-to-date report generated for 6 periods, 2 quarterly columns may be added to the report view. Each quarterly interval column includes data for 3 periods, such as January, February, and March, and the quarterly interval column for months January, February, and March may be displayed after the monthly interval column for March. Furthermore, if the user selects to view monthly, quarterly, and yearly data concurrently, the year-to-date column may also be displayed after the monthly and quarterly intervals.

In an example scenario, when the user selects to view two or more intervals concurrently, the size of the report may exceed a size of the user interface due to a number of intervals displayed in the report, and due to an amount of data and data columns included in each of the data intervals. The report may provide a navigation option 420 to enable the user to continuously scroll to additional data or to navigate to a next page of data.

In a further embodiment, a user may customize a default view to be provided by the ERP system for an initial multi-dimensional business report. For example, the ERP system may default to providing a year-to-date multi-dimensional business report upon receiving an initial request for the report. The user may customize the settings such that the initial report may display quarterly intervals based on the year-to-date data by default. Additionally, the ERP system may determine a default view for the multi-dimensional business report based on a user history of detected user preferences. Furthermore, the ERP system may determine the view for the multi-dimensional business report based on a client device. For example, on the client device, the multi-dimensional business report may be limited to displaying quarterly interval views in an initial report view. In another example embodiment, the data may be displayed in the report based on user credentials and permissions. For example, the ERP system may prevent data from being collected and rendered in the report if the user does not have permission to view the data. In another example, the ERP system may allow the data to be collected and rendered, but the restricted data may be hidden in the report or may not be presented in the report.

In another example embodiment, as illustrated in diagram 400B, the multi-dimensional business report 402 may be associated with graphical representations of the data from the multi-dimensional business report 402. Each graphical representation associated with the financial data report may be automatically updated as a user selects intervals of data to display in the multi-dimensional business report. For example, when a user selects to view monthly, quarterly and yearly data, a graphical representation 422 for a year-to date multi-dimensional business report with quarterly intervals may be updated to display the monthly data 424 in addition to the quarterly data.

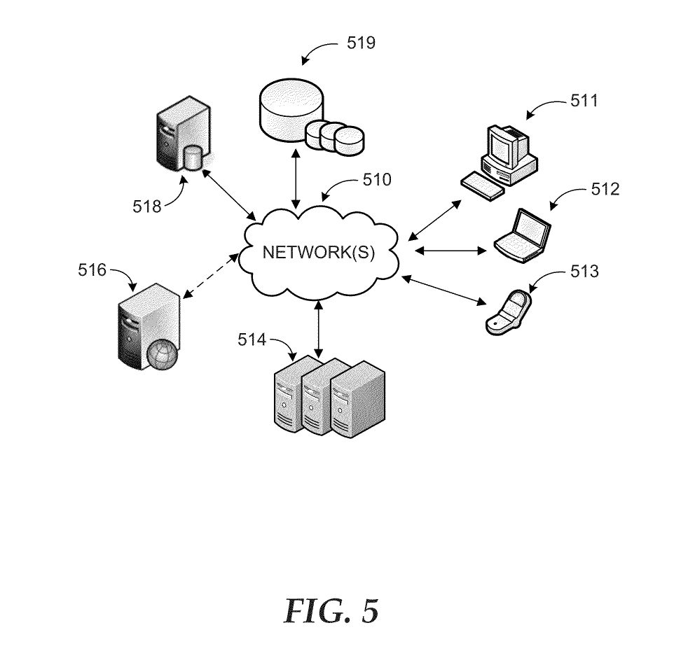

FIG. 5 is an example networked environment, where embodiments may be implemented. A system for providing dynamic report views of financial multi-dimensional data may be implemented via software executed over one or more servers 514 such as a hosted service. The platform may communicate with client applications on individual computing devices such as a smart phone 513, a laptop computer 512, or desktop computer 511 (‘client devices’) through network(s) 510.

Client applications executed on any of the client devices 511-513 may facilitate communications via application(s) executed by servers 514, or on individual server 516. An application executed on one of the servers may facilitate providing dynamic report views of financial data. The application may retrieve relevant data from data store(s) 519 directly or through database server 518, and provide requested services (e.g. document editing) to the user(s) through client devices 511-513.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform for providing a system for providing dynamic report views of financial data. Furthermore, the networked environments discussed in FIG. 5 are for illustration purposes only. Embodiments are not limited to the example applications, modules, or processes.

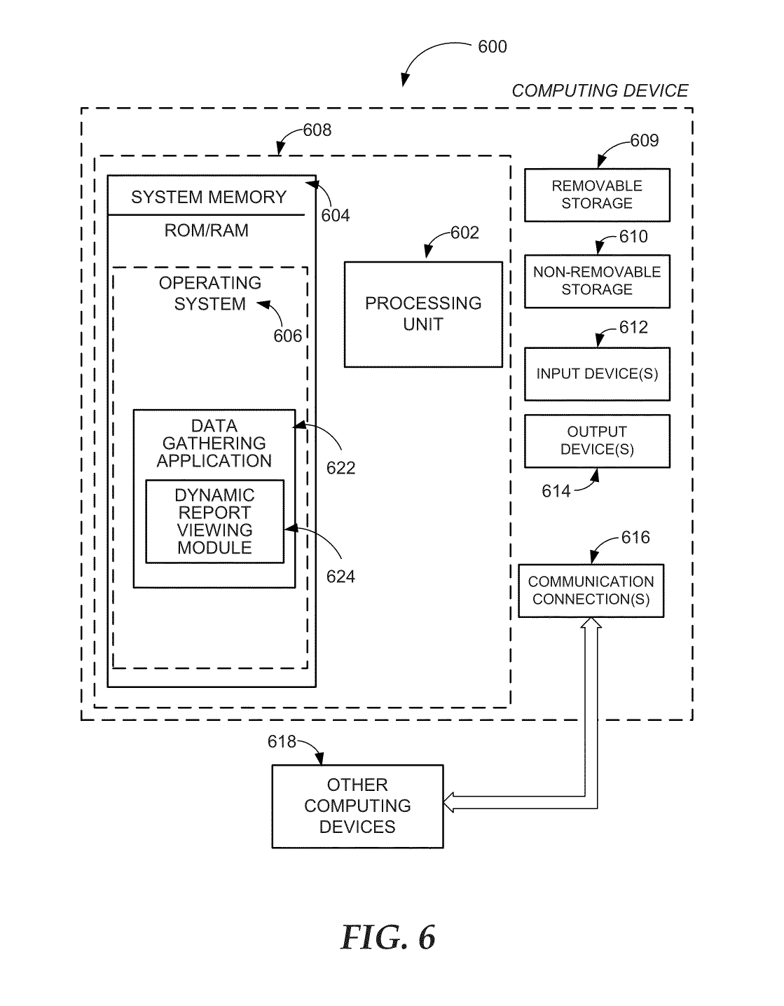

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any computing device executing an application for providing a system for providing dynamic report views of financial data according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 606 suitable for controlling the operation of the platform, such as the WINDOWS® operating systems from MICROSOFT CORPORATION of Redmond, Wash. The system memory 604 may also include one or more software applications such as a data gathering application 622 and a dynamic report viewing module 624.

The data gathering application 622 may be an application enabling a user to request data to be collected and displayed in a multi-dimensional business data report. Example data may be year-to-date financial data for a department or entity. A dynamic report viewing module 624 as part of the data gathering application 622 may facilitate gathering the requested multi-dimensional data, and gathering subsets of the multi-dimensional data included in the requested data. For example, if year-to-date data is requested, data representing smaller intervals such as monthly and quarterly intervals may also be gathered. The dynamic report viewing module 624 may present an initial view of the multi-dimensional business report and may enable a user to select additional data intervals to view in the report. Upon detection of the selection of additional data views, the dynamic report viewing module 624 may automatically update the report to display the additional data views without additional data collection. The data gathering application 622 and the dynamic report viewing module 624 may be separate applications or integrated modules of a hosted service. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM. ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, web servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

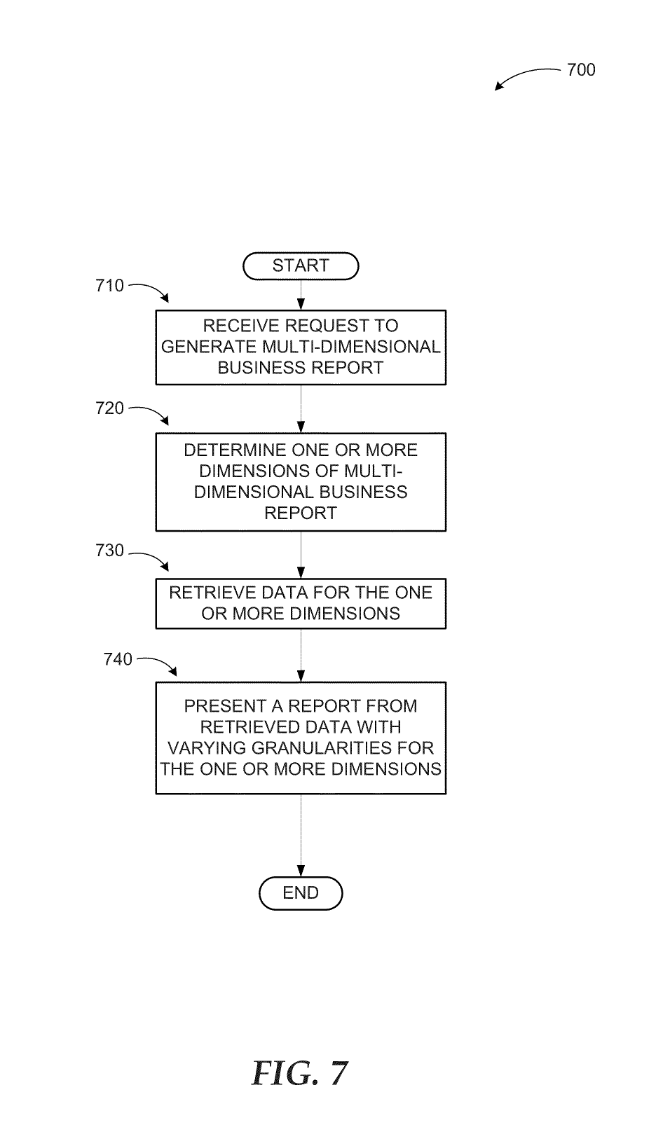

FIG. 7 illustrates a logic flow diagram for process 700 of providing dynamic report views of financial data, according to embodiments. Process 700 may be implemented on a computing device or similar electronic device capable of executing instructions through a processor.

Process 700 begins with operation 710, where a request may be received to generate a multi-dimensional business report.

Operation 710 may be followed by operation 720 where one or more dimensions of the multi-dimensional business report are determined. Example dimensions of the report may be hierarchical dimensions such as time intervals including yearly, quarterly, and monthly time intervals. An initial request may be received for a time dimensions such as a yearly time interval, and associated time intervals of data such as quarterly and monthly data may be determined.

Operation 720 may be followed by operation 730 where data may be retrieved for the one or more dimensions. A server at a data gathering application may receive the request and generate a data query to retrieve data associated with all of the identified dimensions of the request during the data collection.

Operation 730 may be followed by operation 740 where a report from the retrieved data may be presented. The retrieved data may be rendered in a background of the report such that data may be dynamically presented when a user requests to view the data without additional data retrieval from the database. An initial granularity of the identified time dimensions and associated data may be automatically determined based on predefined parameters.

The operations included in process 700 are for illustration purposes. Providing dynamic report views of financial data may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing dynamic report views of multi-dimensional business data, the method comprising:
receiving a request to generate a multi-dimensional business report;
determining one or more dimensions of the multi-dimensional business report;
retrieving data for the one or more dimensions; and
presenting a report from the retrieved data, wherein a granularity of the dimensions and associated data is automatically determined based on predefined parameters.

2. The method of claim 1, further comprising:
determining the granularity of the dimensions and associated data based on an initial request from a user.

3. The method of claim 2, further comprising:
generating a single report with the retrieved data for the one or more dimensions rendered in a background; and
refreshing the report to display a requested granularity of the data.

4. The method of claim 1, further comprising:
generating two or more separate reports for different granularities of data; and
presenting one of the two or more separate reports based on a requested granularity of data.

5. The method of claim 4, further comprising:
providing the two or more separate reports to a local client device for storage until requested for display by a user.

6. The method of claim 1, further comprising:
receiving the request for the multi-dimensional business report at a front end server associated with a data management application.

7. The method of claim 6, further comprising:
passing the request from the front end server to a back end server;
generating a data query to retrieve the data at the back end server; and
providing the retrieved data from the back end server to the front end server for generation of the multi-dimensional business report.

8. The method of claim 7, wherein the granularity of dimensions in the presented report is determined based on one or more of: user history, user credentials, user selection, and user defined settings.

9. The method of claim 8, wherein each granularity includes a varying time dimension.

10. The method of claim 1, further comprising:
receiving a user selection on the presented report to display a selected granularity; and
automatically updating the report to display the selected granularity at a user's client device without retrieving new data for the report.

11. A server for providing dynamic report views of multi-dimensional business data, comprising:
a memory storing instructions;
a processor coupled to the memory, the processor executing a data management application, wherein the data management application is configured to:
receive a request to generate a multi-dimensional business report;
determine one or more time intervals of the multi-dimensional business report;
retrieve data for the one or more time intervals; and
present a report from the retrieved data, wherein a granularity of the time intervals and associated data is automatically determined based on predefined parameters.

12. The server of claim 11, wherein the data management application is further configured to:
receive the request for year-to-date data for the multi-dimensional business report;
determine additional time dimensions of the year-to-date data request, including one or more of: monthly, quarterly and weekly time dimensions; and
retrieve data for the requested data and the additional time dimensions from a database associated with the data management application.

13. The server of claim 12, wherein the data management application is further configured to:
receive a report definition with the request for the multi-dimensional data report, wherein the report definition includes user defined columns and rows of data to be presented in the multi-dimensional business report.

14. The server of claim 13, wherein the data management application is further configured to:
display the same defined rows in each granularity presentation of the report.

15. The server of claim 12, wherein the data management application is further configured to:
receive the request at a front end server associated with the data management application;
pass the request to a back end server configured to generate a query to retrieve data for the one or more time dimensions; and
pass the retrieved data from the back end server to the front end server for generation of the report.

16. The server of claim 12, wherein the data management application is further configured to:
determine a number of quarterly time intervals to display based on: calculating of a number of monthly periods defined in a year-to-date data request, determining a periods-per-quarter (PPQ) value by dividing the number of monthly periods in the year-to-date data by four; and
determine a number of columns of data to be displayed in each quarterly time interval by dividing the number of monthly periods defined in the year-to-date data request by the PPQ value.

17. The server of claim 12, wherein the data management application is further configured to:
display a number of monthly time intervals to display based on calculation of a number of monthly periods defined in a year-to-date data request.

18. The server of claim 1, wherein the multi-dimensional business report is related to one or more business processes including at least one of: profit, revenue, accounting, inventory, and sales.

19. A computer-readable memory device with instructions stored thereon for providing dynamic report views of multi-dimensional business data e, the instructions comprising:
receiving a request to generate a multi-dimensional business report at an enterprise resource planning application;
determining one or more time intervals of the multi-dimensional business report, wherein the time intervals include at least one of: yearly, quarterly, monthly time intervals.
generating a data query at the enterprise resource planning application to retrieve the data;
retrieving data for the one or more time intervals from a database associated with the enterprise resource planning application; and
presenting a report from the retrieved data, wherein a granularity of the time intervals and associated data is automatically determined based on predefined parameters.

20. The computer-readable memory device of claim 19, wherein the instructions further comprise:
receiving a selection from a user to display one or more time dimensions for data in the report;
automatically updating the presented report to display the selected time dimensions without retrieving new data from the database; and
automatically updating an associated graphical visualization of the report based on the displayed time dimension in the report.
